(19) United States
(12) Patent Application Publication
(10) Pub. No.: US 2010/0262366 A1
(43) Pub. Date: Oct. 14, 2010

(54) SYSTEM AND METHOD FOR DISTANCE ESTIMATION

(75) Inventors: Qing Cao, Albany, NY (US); Patricia Denise Mackenzie, Clifton Park, NY (US); Joseph James Salvo, Schenectady, NY (US); Judith Ann Serth-Guzzo, Niskayuna, NY (US); Bouchra Bouqata, Troy, NY (US); Joseph Edward Jesson, Hamilton Square, NJ (US); Robert August Graziano, JR., Niskayuna, NY (US)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: GENERAL ELECTRIC COMPANY, SCHENECTADY, NY (US)

(21) Appl. No.: 12/568,692

(22) Filed: Sep. 29, 2009

Related U.S. Application Data
(60) Provisional application No. 61/168,296, filed on Apr. 10, 2009.

(51) Int. Cl. G01C 21/34; G08G 1/123

(52) U.S. Cl. 701/209; 701/213

(57) ABSTRACT

A mileage estimation system comprising a data collection module, a route determination module, a learning module, and a mileage calculation module is provided. The data collection module receives data corresponding to a position and time of a moving asset from a remote location and the route determination module obtains information from a map database for determining a plurality of routes between at least two location of the moving asset. The learning module in the system determines a route travelled by the moving asset from the plurality of routes based on mileage estimation criterion, and the mileage calculation module estimates the distance travelled by the moving asset based on the route travelled by the moving asset.

### CROSS REFERENCE TO RELATED APPLICATIONS

This application is a non-provisional application of the provisional application, Ser. No. 61/168296, filed Apr. 10, 2009, which is herein incorporated by reference.

### BACKGROUND

The invention relates generally to a mileage estimation system and method and more specifically to the use of Global Positioning System (GPS) traces to estimate mileage.

Mileage is important to many aspects in supply chain management. For example, mileage provides a good measure of asset utilization and is used for maintenance scheduling. However, tracking and monitoring mileage of moving assets (such as trailers, containers, and railcars) without an odometer or an easily accessible mileage device is a challenge. Attempts have been made to solve this problem by creating odometer-like physical devices such as hubometers (devices installed on the driving axle to accumulate distance for various journeys). However, solutions using odometer-like physical devices need manual reading and processing or need to be integrated into a telemetry system. Such systems are labor-intensive and expensive.

Another mileage calculation technique involves a virtual odometer that uses GPS inferred cumulative distances to estimate mileage or distance. The virtual odometer consists of a mileage-processing module on a tracking device in a GPS-enabled tracking system and uses an on-board processor in the GPS tracking device to constantly calculate distance between the current location and last location to accumulate distance. However, the virtual odometer solution requires high sampling frequencies and additional processing power on the GPS tracking devices, which may not be readily available.

Using straight-line distance on a spherical surface to calculate the spatial distance between point A and B is another way of calculating mileage in a GPS enabled tracking system. However, if the data is sparse, for example if only a few messages are sent during a specific trip, the straight-line distance method will not be an accurate method for calculating the mileage between two points. Additionally, roads tend to include curvatures which further reduce straight-line calculation based accuracy.

Therefore, it would be desirable to have an inexpensive system and method to efficiently address above problem.

### BRIEF DESCRIPTION

In accordance with an exemplary embodiment of the present invention, a mileage estimation system is provided. The system includes a data collection module to receive data corresponding to a position and time of a moving asset from a remote location. The system also includes a route determination module to obtain information from a map database for determining a plurality of routes between at least two locations of the moving asset. The system further comprises a learning module for determining a route travelled by the moving asset from the plurality of routes based on mileage estimation criterion. A mileage calculation module is also provided in the system for estimating the distance travelled by the moving asset based on the route travelled by the moving asset.

In accordance with another exemplary embodiment of the present invention, a method for determining distance of a moving asset is provided. The method includes receiving data corresponding to a position and time from the moving asset and generating a plurality of routes between at least two locations of the moving asset based on information from a map database. The method also includes determining a route travelled by the moving asset from the plurality of routes based on previously collected data and estimating the distance travelled by the vehicle based on the route travelled by the moving asset.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of a trailer system with a simplified communication system in accordance with an embodiment of the invention;

FIG. 2 is a diagrammatical representation of a mileage estimation system in accordance with an embodiment of the present invention;

FIG. 3 is a diagrammatical representation of an exemplary trip segment data for use in generating a database of trips;

FIG. 4 is a diagrammatical representation of an example of filtered data using a trip extraction algorithm in accordance with an embodiment of the present invention; and

FIG. 5 is a diagrammatical representation of a mileage estimation system with input and output for each module in accordance with an embodiment of the present invention.

### DETAILED DESCRIPTION

As discussed in detail below, embodiments of the present invention function to provide a system and a method for estimating mileage of moving assets without odometers by integrating a routing service into the data analysis of Global Positioning System (GPS) traces.

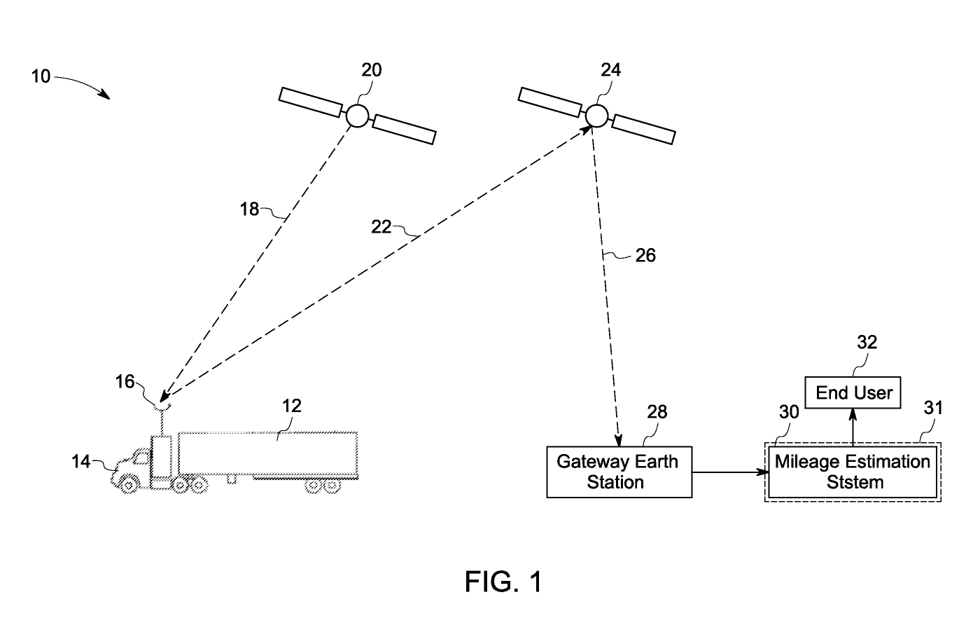

FIG. 1 is a schematic illustration of a trailer system 10 with a simplified communication system. The system 10 includes a trailer 12 carrying goods and a cab 14 attached to a front end of the trailer 12 having a driver. Although the illustrated embodiment shows a trailer, other types of vehicles may be employed. A remote hub 16 is located in the trailer 12. In one embodiment, the remote hub may be located inside the truck 14. The remote hub 16 is configured to receive wireless signals 18 about location information via a location tracking device 20. An example of a location tracking device 20 may include a global positioning satellite (GPS). In another embodiment, the location information may be provided by a non-satellite source such as a WiFi access point, cellular tower or other fixed wireless nodes. The remote hub 16 further transmits wireless signals 22 to a data communication device 24 such as a data satellite. It should be noted that in one embodiment a mobile/cellular tower may alternatively be used. The remote hub 16 may additionally transmit wireless signals to the cab 14 to relay information received via the wireless signals 18 and 22 respectively. One example of such a remote hub 16 is a VeriWise™ hub, produced by the General Electric Company.

When the data communication device 24 comprises a data satellite, the data satellite transmits a wireless signal 26 received from the remote hub 16 to a gateway earth station 28. The wireless signal 26 transmitted by the remote hub 16 may comprise information such as trailer location data, a corresponding time-stamp, trailer ignition data, trailer identification data, and combinations thereof. It may also comprise event data such as ‘trip start’, ‘trip end’, ‘door open’, ‘door close’, ‘cargo loaded’, and ‘cargo empty,’ for example. The gateway earth station 28 is generally controlled by the satellite network provider. Data received from the data communication device is processed in a mileage estimation system 30 in a back end control station 31. The back end control station 31 processes the data, which may include use of more information such as internet data for performing data analytics, and then delivers the results such as mileage information to the end customer 32, either through the web or a direct data feed such as XML data exchange. It should be noted that the term ‘mileage’ as used herein refers to the distance traveled by a vehicle and is not restricted to any particular measurement system e.g., MKS or SI.

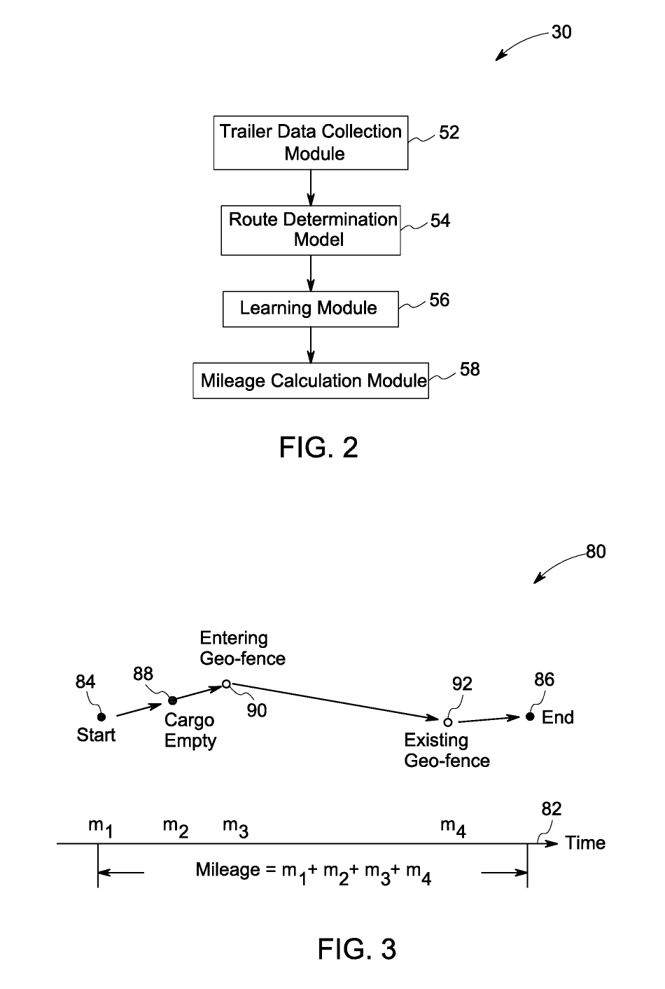

FIG. 2 is a schematic illustration of one embodiment of the mileage estimation system 30 of FIG. 1. The system 30 includes a trailer data collection module 52, a route determination module 54, a learning module 56, and a mileage calculation module 58. The trailer data collection module 52 may communicate with the gateway earth station (element 28 of FIG. 1) via for example cellular communication or Internet. In one embodiment, the trailer data collection module may comprise a GPS data receiver. The gateway earth station typically provides information such as location and status of a trailer, time of the day, and customer type to the trailer data collection module. The data collection module 52 then provides this information to the route determination module 54 for initial route estimation. In one embodiment, the route determination module 54 may include a map database such as Google Maps mapping service, MapQuest Inc mapping service, Yahoo! Map mapping service or Environmental Systems Research Institute (ESRI) mapping service. The route determination module 54 further provides initial route estimation information or candidate routes to the learning module 56 for final route determination. The learning module 56 stores and provides historical trip data of various trailers on a given route. In one embodiment, the learning module enhances the accuracy of the candidate routes based on the historical trip data. The mileage calculation module 58 receives information from the learning module 56 and estimates the distance travelled by a particular trailer.

For example, if the route determination module 54 receives information from the trailer data collection module 52 that a trailer A started its journey from a location X and ended the journey at a location Y, then the route determination module 54 provides routes along the X to Y path to the learning module 56. It should be noted that journey start and journey end are example messages and there may be many more messages throughout the journey of the trailer. The learning module 56 then determines a final route from the candidate routes provided by the route determination module based on a mileage estimation criterion. In one embodiment, the mileage estimation criterion may be the time taken by the trailer A to travel from a location X to a location Y. In another embodiment, the mileage estimation criterion may be the most traveled route in the past, or the route that matches the historical travel time window.

In one embodiment, the learning module enhances the accuracy of candidate routes along the X to Y path sorted from the route determination module from prior trips to select the most likely route. In one embodiment, the prior data is from a customer's own fleet. In another embodiment, the data is from all assets across many customers, if the customers choose to collaborate (that is, let the service provider use their data for this purpose). Another way of enhancing the accuracy of probable routes is by intentionally setting a high messaging rate when initially establishing routes. These routes are taken as baseline and when they are well established; the messaging is reset to more normal rates. Thereafter, routes are validated in an on-going basis. In one embodiment, the route validation is performed by applying weight functions to routes. In another embodiment, frequent trip patterns are added to the learning module as historical knowledge. The learning module ranks the candidate routes provided by the mapping database based on a ranking criterion and infers the most likely route. In one embodiment, the criterion may be based on historical frequency, time-window, or fleet specific patterns. Thus, based on the information from the learning module and the route determination module, the mileage calculation module estimates the distance travelled by the trailer A and calculates its mileage. In another embodiment, the mileage calculation module stores the distance for individual trips and provides accumulated distances as mileage.

FIG. 3 is a schematic representation of exemplary trip segments 80 made by one or more trailers over a period of time 82 that may be used for generating historical data of trips for the learning module. Initially, data corresponding to a position, time and status is received. A typical message from the trailer may be defined as:

P={lat, lon, t, e} (1),

wherein lat is latitude, lon is longitude, t is timestamp and e is an event code or status. Non-limiting examples of an event code are ‘trip start’ 84, ‘trip end’ 86, ‘cargo empty’ 88, ‘entering geo-fence’ 90 and ‘existing geo-fence’ 92. The trip mileage of a trip that starts when a ‘trip start’ message is sent and ends when an ‘trip end’ message is sent is calculated by going through the intermediate message sequence and summing up the distance traveled between consecutive messages.

Intermediate messages are useful in differentiating trips. The obtained trip data is generally sparse in nature and most of the trip data has only start and end points, with no information about which route the asset takes on the trip. Thus, locations of the intermediate messages provide additional information about a trip and can be useful to differentiate trips with different routes. However, exceptions arise due to the noisy nature of the data, and in such cases the data may be filtered out. In an ideal scenario, a ‘trip start’ message and a corresponding ‘trip end’ message appear in pairs, thus defining a trip. However, in practice, ‘trip start’ or ‘trip end’ messages may be missing. For example, a ‘trip start’ message may be followed by another ‘trip start’ message, or a ‘trip end’ message may not have a corresponding ‘trip start’ message. In another embodiment, there may be multiple ‘trip start’ and ‘trip end’ messages missing. This can be inferred by checking if time duration between a ‘trip start’ and ‘trip end’ message exceeds a certain time threshold, say 3 days. In yet another embodiment, a ‘trip start’ message and a corresponding ‘trip end’ message are sent from the same location. This usually occurs when a trailer has traversed a short distance roundtrip. In such a case, a trip extraction algorithm based on a heuristic approach may be used to filter out the data.

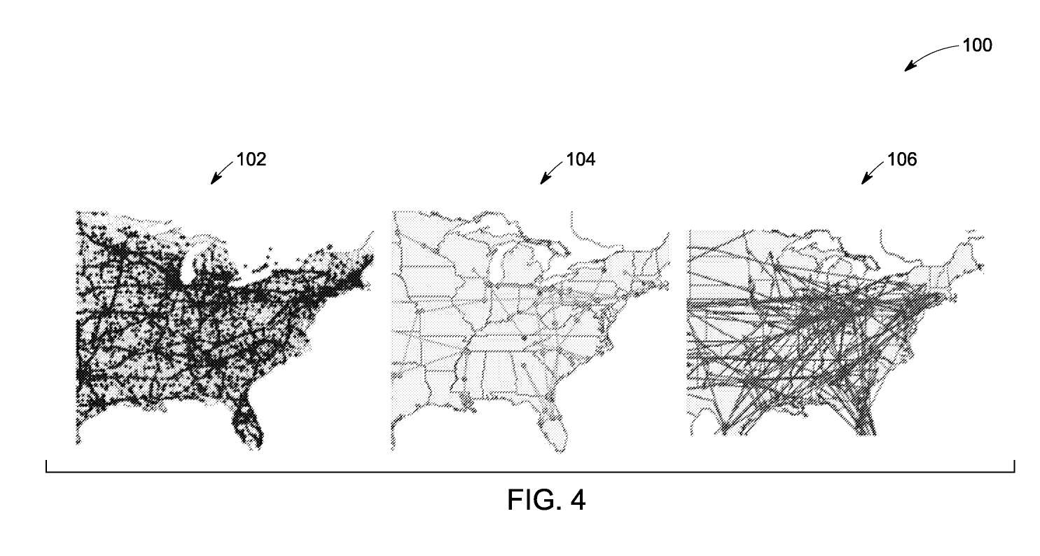

FIG. 4 shows an example 100 of a filtered data using the trip extraction algorithm. The figure shows visualization 102 of a subset of the raw GPS messages, visualization 104 of trips of an individual asset extracted from the subset and visualization 106 of collection of trips by multiple trailers extracted from the GPS dataset. The trip extraction algorithm first retrieves GPS data streams for all trailers. Then, it sequentially processes the GPS data streams, looking for consecutive ‘trip start’ and ‘trip end’ message pairs. The durations and distances between the consecutive ‘trip start’ and ‘trip end’ message pairs are calculated. From the visualization 106, it can be seen that, for a large number of trips, it is difficult to visually explore patterns. Thus, in one embodiment, a trip clustering algorithm is used to identify similar trips that have been repeated by multiple assets, multiple times. In the trip clustering algorithm, first “similarity” between trips is identified by comparing the start and the end location of trips. As used herein, the term ‘similar trips’ refers to trips that have their respective start and end locations spatially close.

Depending on the accuracy of the GPS receiver and the physical size of the start or end location, different GPS coordinates may refer to a same location. In one embodiment, point 1 (42.3463, −71.0974), point 2 (42.3464, −71.0975), and point 3 (42.3460, −71.0976) all refer to the same location i.e. “Fenway park” in Boston, Mass. It should be noted that the coordinates are equivalent to a latitude and longitude of a particular location. Therefore, to determine if a start and end locations of two trips are spatially similar; a distance threshold should be used instead of exact matches.

In one embodiment, in order to address the scalability issue, a grid-based clustering algorithm or technique may be used to discover similar trips. It will be appreciated by those skilled in the art that scalability refers to linear decrease in performance of a clustering algorithm with linear increase in data size. In the grid-based clustering algorithm all of the trips are grid-indexed based on their start and end location and then during the clustering process, instead of including all of the trips in pair-wise comparison for similarity calculations, only those trips with similar grid indices are considered. The advantage of grid-based clustering technique is that it significantly reduces computation time while still yielding sufficiently accurate clustering results.

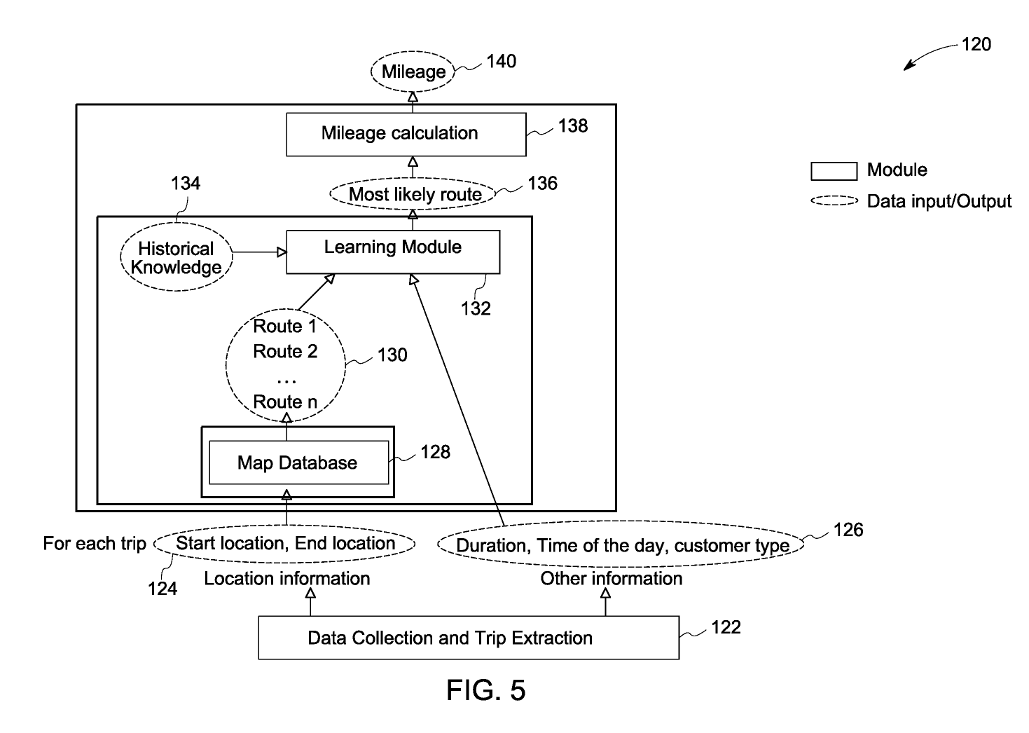

FIG. 5 shows one embodiment of a mileage estimation system 120 along with input and output data of each module. The system 120 includes a data collection and trip extraction module 122, a map database 128, a learning module 132, and a mileage calculation module 138. The data collection and trip extraction module 122 communicates and receives information from the gateway earth station, for example. In one embodiment, the module 122 has two outputs namely location information 124 and other information 126. The location information 124 may include trailer status information for each trip; such as trip start location and trip end location, and the other information 126 may include information such as time of the day, customer type, duration etc. The location information 124 is provided as input to the map database 128. As discussed in one embodiment, the map database utilizes Internet based mapping service and outputs various routes 130 from start location to end location. Various routes 30 of map database 128 are provided as one input signal to the learning module 132. Other inputs signal to the learning module may include historical knowledge 134 and the other information 126. The learning module 132 then based on various inputs determines the most likely route 136 travelled by the trailer and provides it as input to the mileage calculation module 138. Finally, the mileage calculation module 138 calculates the total distance travelled by the trailer and provides mileage output 140.

The advantage of the present mileage estimation system is that it does not need any additional hardware or hardware integration. The system is more accurate than straight-line distance estimation method as the real roads include a lot of curvatures, making them far from being straight lines. The system also diminishes the danger of an incorrect mileage reading from a damaged or faulty hardware device. Another advantage of the system includes generation of flexible mileage statistics such as per day, per week, per month, per trip, per fleet etc. With information from this system, transit companies may have data needed, for example, regarding decisions to relocate trailers to balance workload and to optimize trailer usage using performance based scheduling.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A mileage estimation system comprising:
a data collection module for receiving data corresponding to a position and time of a moving asset from a remote location;
a route determination module for obtaining information from a map database for determining a plurality of routes between at least two locations of the moving asset;
a learning module for determining a route travelled by the moving asset from the plurality of routes based on mileage estimation criterion;
a mileage calculation module for estimating the distance travelled by the moving asset based on the route travelled by the moving asset.

2. The system of claim 1, wherein the data collection module comprises a GPS data receiver.

3. The system of claim 1, further comprising at least one satellite for transmitting position data to the moving asset and at least one other satellite for receiving data from the moving asset.

4. The system of claim 1, wherein the data is sparse in nature.

5. The system of claim 1, wherein the data further comprises a status.

6. The system of claim 5, wherein the status comprises a ‘trip start’ or a ‘trip end’ status.

7. The system of claim 5, wherein the status further comprises an ‘intermediate’ status.

8. The system of claim 5, wherein the data further comprises an event.

9. The system of claim 8, wherein the event comprises a ‘door open’, a ‘door closed’, ‘cargo loaded’, or a ‘cargo empty’ event.

10. The system of claim 1, wherein the moving asset comprises a trailer or a railcar.

11. The system of claim 1, wherein the mileage estimation criterion comprises a most traveled route in the past or a route that matches a historical travel time window.

12. The system of claim 1, wherein the learning module further comprises a trip extraction algorithm to filter out the data.

13. The system of claim 1, wherein the map database comprises an Internet based mapping service.

14. The system of claim 13, wherein the Internet based mapping service comprises Google Maps mapping service, MapQuest Inc. mapping service, Yahoo! Map mapping service or Environmental Systems Research Institute (ESRI) mapping service.

15. The system of claim 1, wherein the learning module is further configured to provide information regarding the plurality of routes based on previously collected data.

16. The system of claim 15, wherein the previously collected data is from the moving asset, other moving assets of a single customer, and/or other moving assets of multiple customers.

17. The system of claim 16, wherein the learning module is configured to store the historical trip data of the moving asset.

18. The system of claim 17, wherein the learning module is configured to regularly update the historical data.

19. A method for determining distance of a moving asset comprising:
receiving data corresponding to a position and time from the moving asset;
generating a plurality of routes between at least two locations of the moving asset based on information from a map database;
determining a route travelled by the moving asset from the plurality of routes based on previously collected data;
estimating the distance travelled by the vehicle based on the route travelled by the moving asset.

20. The method of claim 19, wherein determining the route travelled by the moving asset comprises ranking the plurality of routes based on a ranking criterion.

21. The method of claim 20, wherein the ranking criterion comprises a historical frequency or time-window or a fleet specific pattern.

22. The method of claim 19, wherein determining the route travelled by the moving asset comprises filtering the data using a trip extraction algorithm.

23. The method of claim 22, wherein the trip extraction algorithm is based on a heuristic approach.

24. The method of claim 19, wherein determining the route travelled by the moving asset further comprises filtering the data using a grid based clustering algorithm.

25. The method of claim 1, wherein the map database comprises an Internet based mapping service.
